(19) United States
(12) Patent Application Publication
(10) Pub. No.: US 2020/0005555 A1
(43) Pub. Date: Jan. 2, 2020

(54) Vehicle Performance Wireless Interface

(71) Applicant: K&N Engineering, Inc., Riverside, CA (US)

(72) Inventor: Jonathan Richard Fiello, Yucaipa, CA (US)

(73) Assignee: K&N Engineering, Inc., Riverside, CA (US)

(21) Appl. No.: 16/455,422

(22) Filed: Jun. 27, 2019

Related U.S. Application Data
(60) Provisional application No. 62/692,566, filed on Jun. 29, 2018.

(51) Int. Cl. G07C 5/00; G07C 5/08; G06Q 30/06

(52) U.S. Cl. CPC G07C 5/008; G07C 5/006; G06Q 30/0641; G07C 5/0825; G07C 5/0841; G07C 5/0808

(57) ABSTRACT

An apparatus and a method are provided for a vehicle diagnostic communications system. A component systems package is configured to present OBD-II data monitoring and interactivity. The component systems package is a software application that operates on a mobile device and communicates with a wireless scan tool connected to an OBD-II of a vehicle by way of a wireless connection. A dashboard system displays virtual dashboards including digital gauges, analog gauges, indicator lights, and the like. A driver performance system combines captured video and OBD-II data recorded during operation of the vehicle to assist with improving the driving skills of an end-user. A maintenance tracking and notification system displays notifications when component malfunctions are detected by way of a diagnostic system to ensure that the vehicle is properly serviced and operating optimally. A routing system enables the end-user to obtain new parts and supplies in response to the notifications.

### PRIORITY

This application claims the benefit of and priority to U.S. Provisional Application, entitled “Vehicle Performance Wireless Interface,” filed on Jun. 29, 2018 and having application Ser. No. 62/692,566, the entirety of said application being incorporated herein by reference.

### FIELD

Embodiments of the present disclosure generally relate to the field of vehicle diagnostics. More specifically, embodiments of the disclosure relate to systems and methods for a vehicle diagnostic communication system configured to present OBD-II data monitoring and interactivity.

### BACKGROUND

The Environmental Protection Agency (EPA) has required vehicle manufacturers to install on-board diagnostics (OBD) for emission control on automobiles and light-duty trucks since model year 1996. On-board diagnostic systems, such as computers, microcontrollers, and sensors, monitor emission control systems of a vehicle to detect any malfunction or deterioration that causes emissions to exceed EPA-mandated thresholds. An OBD system typically includes, for example, an oxygen sensor located in the exhaust manifold of the vehicle.

The EPA requires that all information monitored or calculated by OBD systems is made available through a standardized, serial 16-cavity connector referred to as an Assembly Line Diagnostic Link (ALDL) or an OBD connector. For vehicles made after 1996, the 16-cavity connector is referred to as an OBD-II connector. Further, when emission thresholds are exceeded, diagnostic information characterized by OBD systems must be stored in a central computer of the vehicle for use during diagnosis and repair.

A second generation of OBD systems, referred to as “OBD-II” systems, monitors a wide range of data that indicate the performance of the host vehicle, including, for example emissions performance, vehicle speed, mileage, engine temperature, intake manifold pressure, and the like. In some instances, OBD-II systems also store manufacturer-specific data, such as data relating to the vehicle's engine, transmission, brakes, alarm, entertainment systems, and the like. Typically, OBD-II systems monitor codes referred to as diagnostic trouble codes (DTCs) that are capable of indicating mechanical and electrical problems with the vehicle.

Moreover, modern vehicles typically have electronic control units (ECUs) that are configured to control internal electromechanical actuators, such as, for example, fuel-injector pulses, spark-plug timing, anti-lock braking systems, and the like. Most ECUs transmit status and diagnostic information over a shared, standardized electronic buss in the vehicle. The buss serves as an on-board computer network with many processors that transmit and receive data. The primary computers in this on-board computer network are an electronic-control module (ECM) and a power-control module (PCM). The ECM typically accesses computers and microcontrollers that monitor and control engine functions, such as a cruise-control module, a spark controller, an exhaust/gas recirculation system, and the like. The PCM often controls and monitors ECUs associated with the power train, such as, for example, the engine, transmission, and braking systems.

During vehicle servicing, data from the standardized buss can be accessed by way of external engine-diagnostic equipment, commonly referred to as “scan tools,” that connect to the above-mentioned OBD-II connector, typically located under the vehicle's dashboard on the driver's side. Data transferred through the connector to the scan tool generally identify a status of the vehicle and whether or not a specific component of the vehicle has malfunctioned. Many modern scan tools are capable of wireless communication and thus are capable of uploading data to an external computer, such as a desktop, a tablet, a server, a mobile phone, a personal digital assistant (PDA), a personal communicator, a network router or hub, a wireless access point (AP) or repeater, and the like. As will be appreciated, using a scan tool makes vehicle servicing more efficient and cost-effective.

### SUMMARY

An apparatus and a method are provided for a vehicle diagnostic communications system. The vehicle diagnostic communications system comprises an application server system which includes at least one processor and has connectivity to a wireless scan tool that is connectable to an OBD-II connector of a vehicle. A component systems package is configured to present OBD-II data monitoring and interactivity by way of at least a dashboard system, a driver performance system, a diagnostic system, a maintenance tracking and notification system, and a routing system. In some embodiments, the component systems package comprises a software application configured to operate on a mobile device and communicate with the wireless scan tool by way of a wireless connection, including any of Bluetooth, WiFi, NFC, and the like. The dashboard system is configured to display one or more virtual dashboards including digital gauges, analog gauges, indicator lights, and the like. The driver perfoimance system is configured to combine captured video and OBD-II data recorded during operation of the vehicle so as to assist with improving the driving skills of an end-user. The diagnostic system, the maintenance tracking and notification system, and the routing system are configured to operate cooperatively so as to ensure that the vehicle is properly serviced and operating optimally. The maintenance tracking and notification system is configured to display a notification when a component malfunction is detected by way of the diagnostic system. The routing system is configured to enable the end-user to obtain new parts and supplies in response to notifications issued by the maintenance tracking and notification system.

In an exemplary embodiment, a vehicle diagnostic communications system comprises: an application server system which comprises at least one processor and has connectivity to a wireless scan tool that is connectable to an OBD-II connector of a vehicle; a component systems package configured to present OBD-II data monitoring and interactivity by way of at least a dashboard system, a driver performance system, a diagnostic system, a maintenance tracking and notification system, and a routing system; and an interface configured to provide access to the component systems package.

In another exemplary embodiment, the dashboard system is configured to display one or more virtual dashboards including digital gauges, analog gauges, indicator lights, and the like. In another exemplary embodiment, the driver performance system is configured to assist with improving the driving skills of an end-user. In another exemplary embodiment, the driver performance system is configured to record video during operation of the vehicle. In another exemplary embodiment, the driver performance system is configured to combine captured video and OBD-II data recorded during operation of the vehicle.

In another exemplary embodiment, the diagnostic system, the maintenance tracking and notification system, and the routing system are configured to operate cooperatively so as to ensure that the vehicle is properly serviced and operating optimally. In another exemplary embodiment, the diagnostic system is configured to read the OBD-II data obtained by way of the wireless scan tool and indicate any identified malfunctioning components comprising the vehicle. In another exemplary embodiment, the maintenance tracking and notification system is configured to cross-reference the OBD-II data received from the scan tool with scheduled maintenance intervals associated with vehicle. In another exemplary embodiment, the maintenance tracking and notification system is configured to display a notification when the OBD-II data indicate that the vehicle is overdue for servicing or maintenance is required. In another exemplary embodiment, the maintenance tracking and notification system is configured to display a notification when a component malfunction is detected by way of the diagnostic system.

In another exemplary embodiment, the routing system is configured to enable an end-user to quickly and easily obtain new parts and supplies in response to notifications issued by the maintenance tracking and notification system. In another exemplary embodiment, the maintenance tracking and notification system is configured to display a Buy Now button pertaining to detected vehicle malfunctions. In another exemplary embodiment, the routing system is configured to direct the end-user to a website related to one or more parts suppliers when the end-user selects the Buy Now button, the one or more parts suppliers providing new parts and supplies pertaining to the detected malfunction.

In another exemplary embodiment, the component systems package comprises a software application configured to operate on a mobile device and communicate with the wireless scan tool by way of a wireless connection. In another exemplary embodiment, the wireless connection comprises any wireless protocol suitable for transferring data, including any of Bluetooth, WiFi, NFC, and the like.

In an exemplary embodiment, a method for a vehicle diagnostic communications system comprises: providing an application server system that comprises at least one processor and has connectivity to a wireless scan tool that is connectable to an OBD-II connector of a vehicle; configuring a component systems package to present OBD-II data monitoring and interactivity by way of at least a dashboard system, a driver performance system, a diagnostic system, a maintenance tracking and notification system, and a routing system; and configuring an interface to provide access to the component systems package.

In another exemplary embodiment, configuring the component system package includes configuring the dashboard system to display one or more virtual dashboards including digital gauges, analog gauges, indicator lights, and the like. In another exemplary embodiment, configuring the component system package includes configuring the driver perfoiniance system to assist with improving the driving skills of an end-user, record video during operation of the vehicle, and combine captured video and OBD-II data recorded during operation of the vehicle. In another exemplary embodiment, configuring the component system package includes configuring the diagnostic system, the maintenance tracking and notification system, and the routing system to operate cooperatively to ensure that the vehicle is properly serviced and operating optimally. In another exemplary embodiment, configuring the component system package includes configuring the diagnostic system to read OBD-II data obtained by way of a wireless scan tool and indicate any identified malfunctioning components comprising the vehicle. In another exemplary embodiment, configuring the component system package includes configuring the routing system to enable an end-user to quickly and easily obtain new parts and supplies in response to notifications issued by the maintenance tracking and notification system.

### BRIEF DESCRIPTION OF THE DRAWINGS

The drawings refer to embodiments of the present disclosure in which:

FIG. 1 is a schematic illustrating an exemplary embodiment of a vehicle diagnostic communication system in accordance with the present disclosure;

FIG. 2 illustrates an exemplary use environment wherein a wireless connection is established between a wireless scan tool connected to an OBD-II connector of a vehicle and a mobile device;

FIG. 3A illustrates an exemplary embodiment of a touch screen that may be displayed on of the mobile device of FIG. 2 while the wireless scan tool is connected to the OBD-II connector of the vehicle;

FIG. 3B illustrates an exemplary embodiment of a dashboard that may be displayed on of the mobile device of FIG. 2 while the wireless scan tool is connected to the OBD-II connector of the vehicle;

FIG. 4 illustrates an exemplary embodiment of a driver performance screen that may be displayed on the mobile device of FIG. 2 while the wireless scan tool is connected to the OBD-II connector of the vehicle; and

FIG. 5 is a block diagram illustrating an exemplary data processing system which may be used with embodiments of a vehicle diagnostic communication system according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first vehicle,” may be made. However, the specific numeric reference should not be interpreted as a literal sequential order but rather interpreted that the “first vehicle” is different than a “second vehicle.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the Environmental Protection Agency (EPA) requires vehicle manufacturers to install on-board diagnostics (OBD) for emission control on automobiles and light-duty trucks. On-board diagnostic systems, such as computers, microcontrollers, and sensors, monitor emission control systems of a vehicle to detect any malfunction or deterioration that causes emissions to exceed EPA-mandated thresholds. All information monitored or calculated by OBD systems is made available through a standardized, serial 16-cavity connector referred to as an Assembly Line Diagnostic Link (ALDL) or an OBD connector, referred to as an OBD-II connector for vehicles made after 1996. When emission thresholds are exceeded, diagnostic information characterized by OBD systems must be stored in a central computer of the vehicle for use during diagnosis and repair. During vehicle servicing, data can be accessed by way of external engine-diagnostic equipment, commonly referred to as “scan tools,” that connect to the OBD-II connector. Data transferred through the connector to the scan tool generally identify a status of the vehicle and whether or not a specific component of the vehicle has malfunctioned. Many modern scan tools are capable of wireless communication and thus are capable of uploading data to an external computer, such as a desktop, a tablet, a server, a mobile phone, a personal digital assistant (PDA), a personal communicator, a network router or hub, a wireless access point (AP) or repeater, and the like. Embodiments disclosed herein include systems and methods for a vehicle diagnostic communication system configured to present OBD-II data monitoring and interactivity.

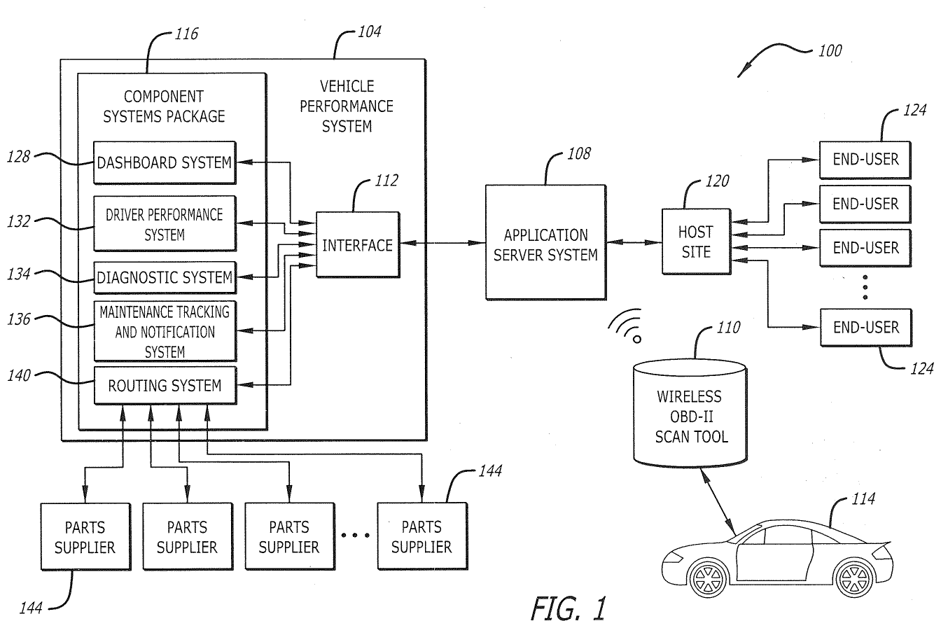

FIG. 1 is a schematic illustrating an exemplary embodiment of a vehicle diagnostic communication system 100 in accordance with the present disclosure. The communication system 100 comprises a vehicle performance system 104 stored on a non-transient machine-readable medium (i.e., a memory) of an application server system 108 which comprises at least one processor and has connectivity to a wireless scan tool 110 that is connected to the OBD-II connector of a vehicle 114. Generally, the wireless scan tool 110 provides performance and status data regarding the vehicle 114 to the vehicle performance system 104, such as, by way of non-limiting example, engine RPM, vehicle speed, coolant temperature, air flow, manifold pressure, barometric pressure, ambient air temperature, boost pressure, wideband AFR, throttle position, spark advance, horsepower and torque calculations, fuel economy (MPG, L/100 km, L/km, etc.), and any other generic OBD-II PIDs that are available.

Moreover, in some embodiments, the vehicle performance and status data provided by way of the wireless scan tool 110 further includes degrees of engine knock, transmission fluid temperature and line pressure, slip across torque converter, torque converter lockup state, current transmission gear, rear differential temperature, charge pressure and/or throttle inlet pressure, secondary intake air pressure (post turbo/supercharger), wastegate duty cycle percentage, cylinder misfire data, cylinder head temperature, engine oil pressure, engine oil temperature, clutch pedal position, and data received from any other sensor on the vehicle, as well as any other manufacturer proprietary/enhanced PIDs that may be accessible.

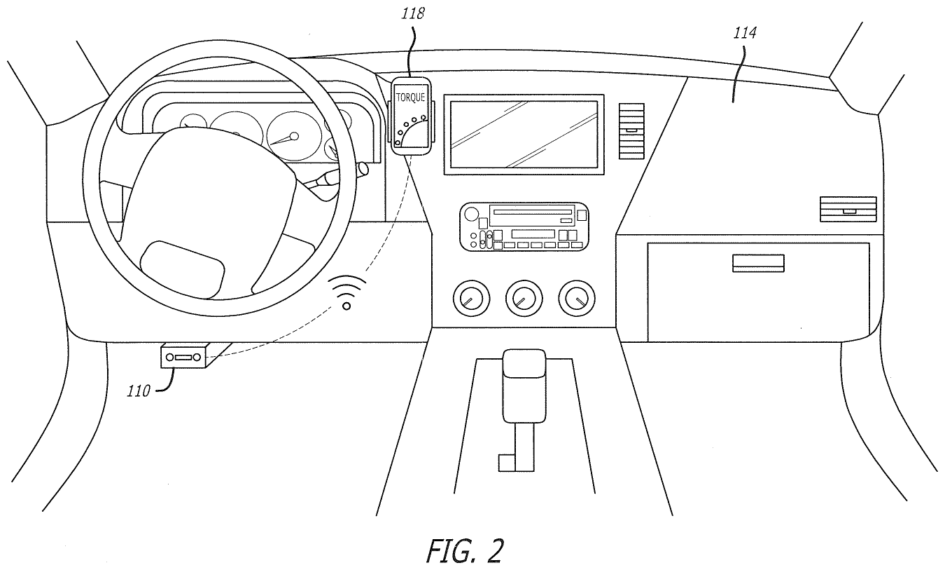

In some embodiments, the vehicle performance system 104 comprises an interface 112 which provides access to a component systems package 116. A host site 120 provides a multiplicity of end-users 124 access to the application server system 108 by way of a communications network, such as the Internet. The end-users 124 comprise vehicle servicing personnel, such as, by way of example, auto mechanics, technicians, vehicle owners, and the like, desiring to access and interact with vehicle status and performance data. In some embodiments, the host site 120 comprises a web-based application by which the end-users 124 interact with the component systems package 116. In some embodiments, the host site 120 may comprise a customized web-based mobile device application which enables service personnel and vehicle owners to directly interact with the component systems package 116. In some embodiments, the host site 120 and the vehicle performance system 104 may comprise a software application configured to operate on a mobile device and communicate with the wireless scan tool 110 by way of a wireless connection. In such embodiments, the end-user 124 connects the wireless scan tool 110 to the OBD-II connector of the vehicle 114 and a wireless connection is established between the wireless scan tool 110 and the mobile device, such as a cellphone 118, as shown in FIG. 2. It is contemplated that the wireless connection between the scan tool 110 and the cellphone 118 may comprise any wireless protocol suitable for transferring data, including any of Bluetooth, WiFi, NFC, and the like, without limitation.

Preferably, each of the end-users 124 may utilize applications stored on the memory of the application server system 108 to send demand signals, or “electronic orders,” to one or more of various parts suppliers 144 so as to receive desired products. The parts suppliers 144 comprise organizations, such as, by way of example, suppliers of parts for automobiles and trucks, manufacturers, vendors, retail locations, and the like. In one embodiment, the component systems package 116 is stored on the memory of the application server system 108, and the interface 112 is a software application which comprises a portion of the vehicle performance system 104, thereby providing access to the component systems package 116. In some embodiments, the component systems package 116 may be services operated by one or more third-party service providers. In such embodiments, the interface 112 may comprise a connection over the communications network, such as an Internet connection, whereby the application server system 108 may send requests to, and receive services from, the one or more third-party service providers.

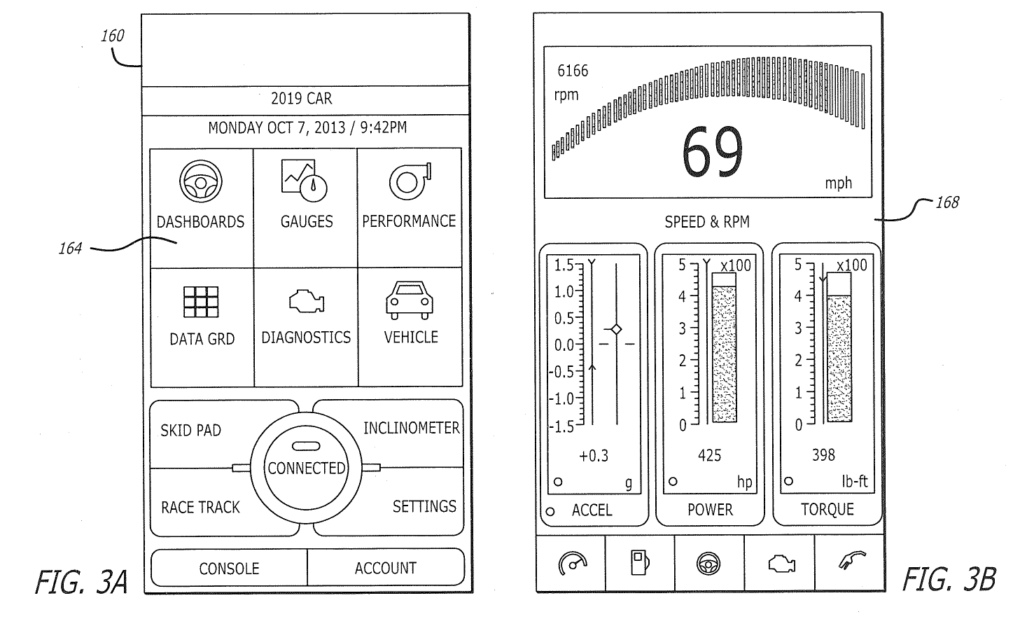

As will be appreciated, the component systems package 116 generally comprises component systems whereby each end-user 124 may interact with the vehicle performance and status data provided by way of the wireless scan tool 110. FIG. 3A illustrates an exemplary embodiment of a touch screen 160 that may be presented to the end-user 124, by way of the cellphone 118, whereby the component systems package 116 may be accessed. For example, the touch screen 160 may include several buttons 164 that enable the end-user 124 to select and operate the component systems comprising the package 116. In the illustrated embodiment of FIG. 1, the component systems package 116 includes a dashboard system 128, a driver perfoimance system 132, a diagnostic system 134, a maintenance tracking and notification system 136, and a routing system 140. In some embodiments, however, the component systems package 116 may comprise other systems in addition to the component systems illustrated in FIG. 1, without limitation and without deviating beyond the spirt and scope of the present disclosure. Each of the systems comprising the component systems package 116 is described below.

The dashboard system 128 generally is configured to integrate OBD-II data monitoring and logging into an in-car computing experience. For example, an exemplary embodiment of a dashboard 168 that may be displayed to the end-user 124 by way of the cellphone 118 is shown in FIG. 3B. It is contemplated that the dashboard system 128 is configured to display a wide variety of appealing virtual dashboards including, by way of non-limiting example, digital gauges, analog gauges, indicator lights, and the like.

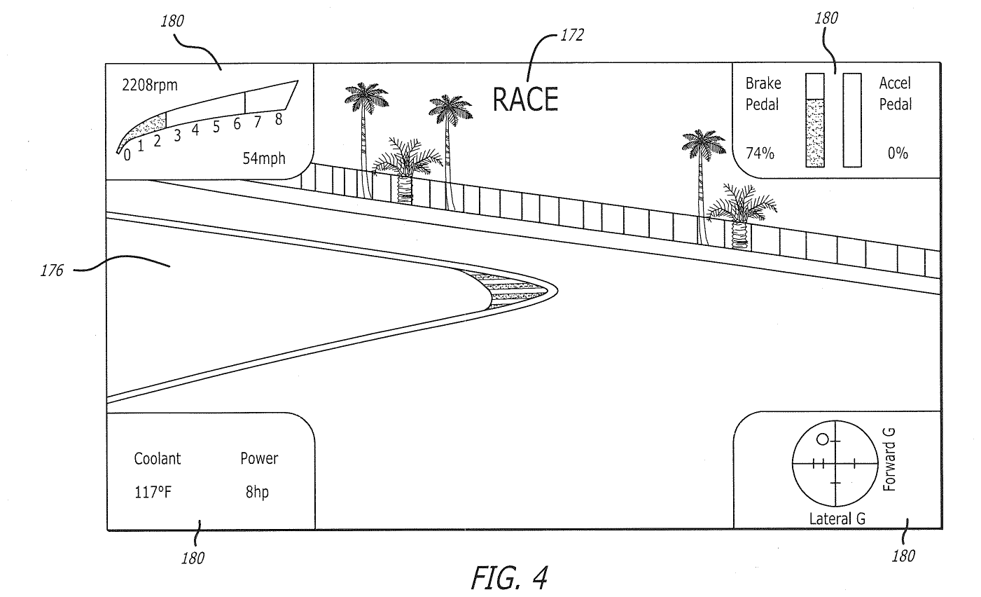

The driver performance system 132 is configured to assist with improving the driving skills of the end-user 124. It is contemplated that the driver performance system 132 is particularly suitable for improving competitive driving skills of the end-user 124, such as road racing, autocross, rally, off-road, drag racing, and the like. In some embodiments, the driver performance system 132 enables the end-user 124 to record video during racing, for example, by way of the cellphone 118. The driver performance system 132 may then combine the captured video with OBD-II data recorded during the race to enable the end-user 124 to identify driver errors so as to facilitate improved racing performance. FIG. 4 illustrates an exemplary embodiment of a driver performance screen 172 that may be displayed by way of the cellphone 118. The driver performance screen 172 includes captured video 176 and one or more screened data overlays 180. The data overlays 180 may comprise any of horsepower, engine RPM, vehicle speed, engine coolant temperature, brake pedal, throttle position, G forces, and any of the OBD-II data that are relevant to driver performance. It is further contemplated that the driver performance system 132 is configured to enable the end-user 124 to record, save, and playback video, audio, and vehicle data recording during driving.

With reference again to FIG. 1, it is contemplated that, in some embodiments, the diagnostic system 134, the maintenance tracking and notification system 136, and the routing system 140 may operate cooperatively to ensure that the vehicle 114 is properly serviced and operating optimally. The diagnostic system 134 is configured to read the OBD-II data obtained by way of the wireless scan tool 110 and indicate any identified malfunctioning components of the vehicle 114. The maintenance tracking and notification system 136 is configured to cross-reference the OBD-II data received from the scan tool 110 with scheduled maintenance intervals associated with vehicle 114. If the OBD-II data indicate that the vehicle 114 is overdue for servicing or maintenance is required, then the system 136 may display a notification to the end-user 124.

It is contemplated that the maintenance tracking and notification system 136 operates in conjunction with the diagnostic system 134, as well. As such, in addition to identifying maintenance schedules, the maintenance tracking and notification system 136 may display a notification to the end-user 124 when a component malfunction is detected by way of the diagnostic system 134. For example, the maintenance tracking and notification system 136 may indicate that the vehicle 114 needs a new air filter if either the service interval pertaining to the air filter has been exceeded or the diagnostic system 134 detects a malfunction indicating a dirty of clogged air filter.

The routing system 140 is configured to enable the end-user 124 to quickly and easily obtain new parts and supplies in response to the notifications issued by the maintenance tracking and notification system 136. In some embodiments, the maintenance tracking and notification system 136 is configured to display a Buy Now button pertaining to detected vehicle malfunctions. When the end-user 124 selects the. Buy Now button, the routing system 140 directs the cellphone 118 to a website related to one of the parts suppliers 144 whereby the end-user 124 may obtain new parts and supplies pertaining to the detected malfunction. For example, in the above case of a dirty air filter, when the end-user 124 selects the Buy Now button, the routing system 140 redirects the cellphone 118 to the website of the part supplier 144 that sells replacement air filters and/or air filter cleaning kits. As will be appreciated, once the cellphone 118 is redirected to the website, the end-user 124 purchase the need parts and/or supplies, as desired.

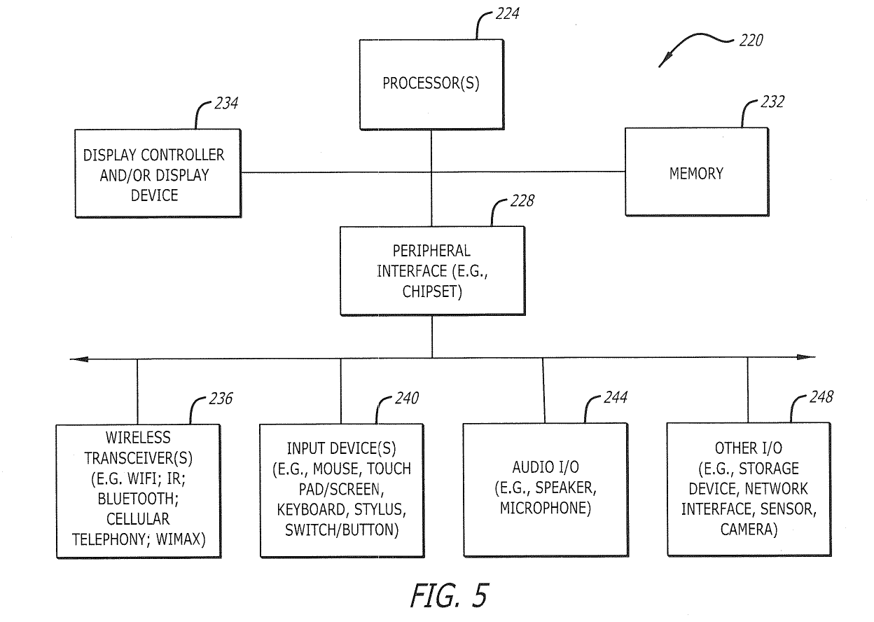

FIG. 5 is a block diagram illustrating an exemplary data processing system 220 which may be used with the vehicle diagnostic communication system 100 to perform any of the processes or methods described herein. System 220 may represent a desktop, a tablet, a server, a mobile phone, a personal digital assistant (PDA), a personal communicator, a network router or hub, a wireless access point (AP) or repeater, a set-top box, or a combination thereof.

In an embodiment, illustrated in FIG. 5, system 220 includes a processor 224 and a peripheral interface 228, also referred to herein as a chipset, to couple various components to the processor 224, including a memory 232 and devices 236-248 via a bus or an interconnect. Processor 224 may represent a single processor or multiple processors with a single processor core or multiple processor cores included therein. Processor 224 may represent one or more general-purpose processors such as a microprocessor, a central processing unit (CPU), or the like. More particularly, processor 224 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 224 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 224 is configured to execute instructions for performing the operations and steps discussed herein.

Peripheral interface 228 may include a memory control hub (MCH) and an input output control hub (ICH). Peripheral interface 228 may include a memory controller (not shown) that communicates with a memory 232. The peripheral interface 228 may also include a graphics interface that communicates with graphics subsystem 234, which may include a display controller and/or a display device. The peripheral interface 228 may communicate with the graphics device 234 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 224. In such a configuration, the peripheral interface 228 operates as an interface chip performing some functions of the MCH and ICH. Furthermore, a graphics accelerator may be integrated within the MCH or the processor 224.

Memory 232 may include one or more volatile storage (or memory) devices, such as random access memory (RAM), dynamic RAM (DRAM), synchronous DRAM (SDRAM), static RAM (SRAM), or other types of storage devices. Memory 232 may store information including sequences of instructions that are executed by the processor 224, or any other device. For example, executable code and/or data of a variety of operating systems, device drivers, firmware (e.g., input output basic system or BIOS), and/or applications can be loaded in memory 232 and executed by the processor 224. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 228 may provide an interface to 10 devices, such as the devices 236-248, including wireless transceiver(s) 236, input device(s) 240, audio I0 device(s) 244, and other I0 devices 248. Wireless transceiver 236 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 240 may include a mouse, a touch pad, a touch sensitive screen (which may be integrated with display device 234), a pointer device such as a stylus, and/or a keyboard (e.g., physical keyboard or a virtual keyboard displayed as part of a touch sensitive screen). For example, the input device 240 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 244 may include a speaker and/or a microphone to facilitate voice-enabled functions, such as voice recognition, voice replication, digital recording, and/or telephony functions. Other optional devices 248 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 248 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 5 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A vehicle diagnostic communications system, comprising:
an application server system which comprises at least one processor and has connectivity to a wireless scan tool that is connectable to an OBD-II connector of a vehicle;
a component systems package configured to present OBD-II data monitoring and interactivity by way of at least a dashboard system, a driver performance system, a diagnostic system, a maintenance tracking and notification system, and a routing system; and
an interface configured to provide access to the component systems package.

2. The system of claim 1, wherein the dashboard system is configured to display one or more virtual dashboards including digital gauges, analog gauges, indicator lights, and the like.

3. The system of claim 1, wherein the driver performance system is configured to assist with improving the driving skills of an end-user.

4. The system of claim 3, wherein the driver performance system is configured to record video during operation of the vehicle.

5. The system of claim 4, wherein the driver performance system is configured to combine captured video and OBD-II data recorded during operation of the vehicle.

6. The system of claim 1, wherein the diagnostic system, the maintenance tracking and notification system, and the routing system are configured to operate cooperatively so as to ensure that the vehicle is properly serviced and operating optimally.

7. The system of claim 6, wherein the diagnostic system is configured to read the OBD-II data obtained by way of the wireless scan tool and indicate any identified malfunctioning components comprising the vehicle.

8. The system of claim 6, wherein the maintenance tracking and notification system is configured to cross-reference the OBD-II data received from the scan tool with scheduled maintenance intervals associated with vehicle.

9. The system of claim 8, wherein the maintenance tracking and notification system is configured to display a notification when the OBD-II data indicate that the vehicle is overdue for servicing or maintenance is required.

10. The system of claim 8, wherein the maintenance tracking and notification system is configured to display a notification when a component malfunction is detected by way of the diagnostic system.

11. The system of claim 10, wherein the routing system is configured to enable an end-user to quickly and easily obtain new parts and supplies in response to notifications issued by the maintenance tracking and notification system.

12. The system of claim 11, wherein the maintenance tracking and notification system is configured to display a Buy Now button pertaining to detected vehicle malfunctions.

13. The system of claim 12, wherein the routing system is configured to direct the end-user to a website related to one or more parts suppliers when the end-user selects the Buy Now button, the one or more parts suppliers providing new parts and supplies pertaining to the detected malfunction.

14. The system of claim 1, wherein the component systems package comprises a software application configured to operate on a mobile device and communicate with the wireless scan tool by way of a wireless connection.

15. The system of claim 14, wherein the wireless connection comprises any wireless protocol suitable for transferring data, including any of Bluetooth, WiFi, NFC, and the like.

16. A method for a vehicle diagnostic communications system, the method comprising:
providing an application server system that comprises at least one processor and has connectivity to a wireless scan tool that is connectable to an OBD-II connector of a vehicle;
configuring a component systems package to present OBD-II data monitoring and interactivity by way of at least a dashboard system, a driver performance system, a diagnostic system, a maintenance tracking and notification system, and a routing system; and
configuring an interface to provide access to the component systems package.

17. The method of claim 16, wherein configuring the component system package includes configuring the dashboard system to display one or more virtual dashboards including digital gauges, analog gauges, indicator lights, and the like.

18. The method of claim 16, wherein configuring the component system package includes configuring the driver performance system to assist with improving the driving skills of an end-user, record video during operation of the vehicle, and combine captured video and OBD-II data recorded during operation of the vehicle.

19. The method of claim 16, wherein configuring the component system package includes configuring the diagnostic system, the maintenance tracking and notification system, and the routing system to operate cooperatively to ensure that the vehicle is properly serviced and operating optimally.

20. The method of claim 16, wherein configuring the component system package includes configuring the diagnostic system to read OBD-II data obtained by way of a wireless scan tool and indicate any identified malfunctioning components comprising the vehicle.

21. The method of claim 16, wherein configuring the component system package includes configuring the routing system to enable an end-user to quickly and easily obtain new parts and supplies in response to notifications issued by the maintenance tracking and notification system.
